(19) United States
(12) Patent Application Publication
(10) Pub. No.: US 2024/0379251 A1
(43) Pub. Date: Nov. 14, 2024

(54) METHOD OF AND APPARATUS FOR WAVE ENERGY REACTION

(71) Applicants: Yasuo ISHIKAWA, Kamakura-shi, Kanagawa (JP); Ishikawa LABO Corporation, Koza-gun, Kanagawa (JP)

(72) Inventor: Yasuo Ishikawa, Kamakura-shi (JP)

(73) Assignees: Yasuo ISHIKAWA, Kamakura-shi, Kanagawa (JP); Ishikawa LABO Corporation, Koza-gun, Kanagawa (JP)

(21) Appl. No.: 18/196,042

(22) Filed: May 11, 2023

(51) Int. Cl. G21B 3/00

(52) U.S. Cl. CPC G21B 3/006; G21B 3/008

(57) ABSTRACT

Metal sodium (Na) is accommodated, as an amplification agent, into a reaction cylinder 1 which can eject electromagnetic waves by heating it thereby to form a wave energy space in which a high energy is generated intermittently, fine particles of the metal sodium and constituent atoms of gas to be treated being provided with some nuclei each having a vacuum space, the vacuum space being broken by the high energy to absorb the high energy, whereby Dr. NAMBU theory can be applied to a simple and concrete apparatus.

### TECHNICAL FIELD

This invention relates to a method of and an apparatus for wave energy reaction, which can apply “Dr. NAMBU's theory” to a concrete useful apparatus in the field of quantum mechanics.

### BACKGROUND OF THE TECHNOLOGY

Twenty years ago, the inventor of this application made a search for production of hydrogen and found a technology for producing hydrogen by means of catalyst. Then, the inventor visited its developer to see his experiment. According to the developer, when an oxide and a hydroxide were heated in a reaction vessel at a temperature of approximately 700° C. to supply water into the reaction vessel, H and O of water were separated with each other to produce H. The inventor of this invention had suspicion concerning its reaction principle, and continued experiments for 2 or 3 years, so that the inventor was convinced that the reaction was based on a kind of nuclear reaction. Thereafter, the inventor continued to make many substantiate experiments and, at the same time, he studied quantum mechanics. Then, he thought that the nuclear reaction of the experiments might be based on the theory of Dr. YOICHIRO NAMBU who is an authority in the field of quantum mechanics, and Dr. NAMBU advices that symmetry in vacuum universe space is spontaneously broken by e.g., universe rays, strong electromagnetic waves coming from the sun, etc.

### PRIOR ART

Patent Publication 1: Japanese Laid-Open Publication 2022-168898

Patent Publication 2: International Publication WO2021/079843A1

### SUMMARY OF THE INVENTION

### Subject to be Solved by the Invention

The theory of Dr. NAMBU is much creative concerning origin of the universe, and, however, any concrete useful devices have not been yet produced on the basis of the theory. According to the theory, a vacuum space of the universe is collapsing because of “spontaneous symmetry breaking”.

In addition, at present in fission reaction used in the field of atomic power generation, a high heat occurs at time of fission in a chaining manner to increase the possibility of a big accident. Therefore, people expect a safer nuclear reactor.

### Means for Solving the Subject

The subject of this invention is solved by a safe simple method of wave energy space reaction, wherein: an amplification agent is accommodated in a reaction cylinder ejecting electromagnetic waves by its heating to amplify energy of the electromagnetic waves so as to form a wave energy space including ionized fine particles of the amplification agent and electrons jumping out of the fine particles; a high energy is generated in accordance with “uncertainty principle” in the wave energy space at a predetermined period; both atoms of the amplification agent and gas to be supplied to the wave energy space for detoxification comprise masses smaller than that of iron, respectively; a vacuum space of nucleus of each atom is exposed to the high energy generated in the wave energy space to cause “artificial symmetry breaking” so as to cut off nuclear force therein artificially at any time; and the high energy generated in the wave energy space can be absorbed by separating protons from neutrons in each nucleus.

The reaction cylinder ejects electromagnetic waves including many and different amplitudes and frequencies.

The reaction cylinder is in the shape of circle, rectangular or hexagon and ejects standing waves by being heated.

The amplification agent comprises at least one atom of alkaline metals (Na, K, Li, etc.), alkaline earth metals (Mg, Ca, etc.), active metals (Zn, Al, etc.) or at least one compound including the one atom in those metals, and gas to be treated in the reaction cylinder is carbon dioxide (CO₂), steam (H₂O) or ammonia (NH₃).

A wave energy space reaction apparatus, comprising: a reaction cylinder which is made of material for ejecting electromagnetic waves by its heating; an amplification agent which is accommodated in the reaction cylinder in order to amplify energy of the electromagnetic waves and has a smaller mass than that of iron; a heating equipment for heating the reaction cylinder and the amplification agent therein; a wave space which includes therein a first mixture of ionized fine particles as the amplification agent and electrons jumping out of the fine particles or a second mixture of the first mixture and constituent atoms each having a smaller mass than that of iron in gas supplied into the wave energy space to be made harmless, and which has wave natures and particle natures at the same time so as to generate a high energy intermittently by means of an interaction between the electromagnetic waves and the first or second mixture; a vacuum space which is formed in a nucleus of each atom of the first or second mixture and which hold nuclear force therein.

The reaction cylinder is made of stainless steel or iron.

The heating device comprises a bandlike electric heater wound on the outer circumferential surface of the reaction cylinder.

### Effect of the Invention

According to this invention, the NAMBU theory can be artificially simply applied to a concrete apparatus which has a simple structure without any special material and which can absorb automatically heat generated in the apparatus to avoid an accident by heat, and, further, poisonous gases such as carbon dioxide (CO₂), ammonia (NH₃) etc. can be made harmless. In addition, a lot of hydrogen is obtained from steam (H₂O).

To put it concretely, main parts of this application are a reaction cylinder made of stainless steel, a carbon cylinder, and a heating device. These parts are made of normal material. In addition to these parts, metal sodium (Na) is used as an amplification agent. Furthermore, as the amplification agent and gases to be treated, some elements themselves or gases including some elements, each having a mass smaller than that of iron (Fe) are selected so that collapse of nucleus of each element absorbs the high energy generated in the wave energy space W to operate the apparatus safely. Furthermore, there are protons, neutrons and electrons moving at different high speeds respectively in the reaction cylinder, these particles do not go out of the reaction cylinder.

### BRIEF DESCRIPTION OF THE DRAWINGS

FIG. 1 shows a longitudinal sectional view of a wave energy reaction apparatus.

FIG. 2 shows an explanatory view of standing waves.

FIG. 3 shows a view concerning a shape of the wave energy reaction apparatus.

FIG. 4 shows a view concerning another shape of the wave energy reaction apparatus.

FIG. 5 shows a view concerning still another shape of the wave energy reaction apparatus.

FIG. 6 shows an explanatory view concerning wave packets.

FIG. 7 shows a view concerning change of current value at the time of measurement by a plasma measurement device.

FIG. 8 shows a view concerning a state of generation of energy in the wave energy space.

FIG. 9 shows a view concerning change of temperature in the wave energy space.

FIG. 10 shows an explanatory view concerning an amplification function of an Na atom.

FIG. 11 shows a view of a graph concerning a binding energy with respect to a mass number of each atom.

FIG. 12 shows an explanatory view concerning a structure of nucleus of an oxygen and behavior of a proton and a neutron at a time when a nuclear force is cut off.

FIG. 13 shows an explanatory view concerning concrete examples of reunion.

### EMBODIMENT OF THE INVENTION

The embodiments of this invention will now be explained with reference to the drawings.

### 1) General Structure

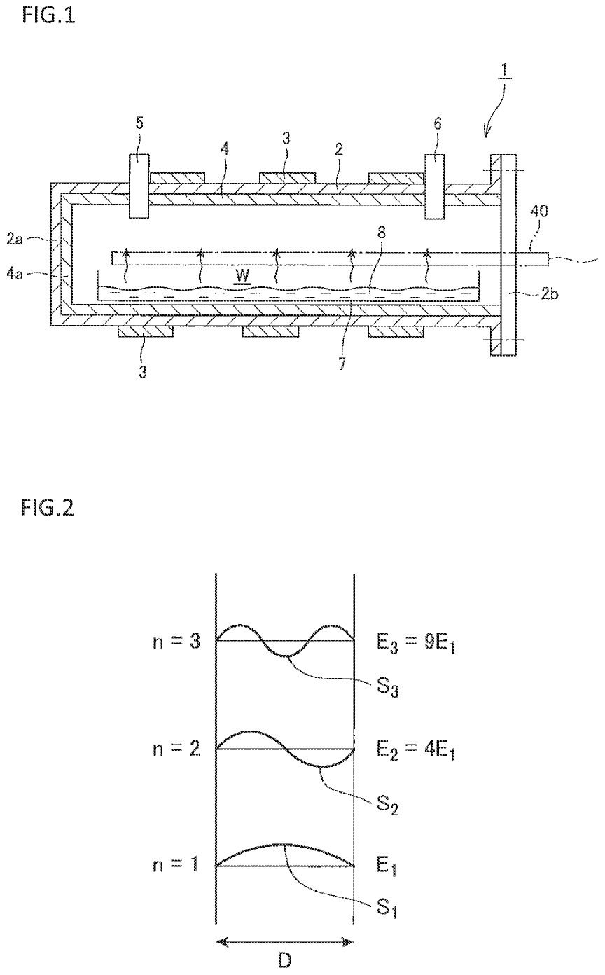

In FIG. 1, a reaction cylinder 1 of this invention has a main body 2 in shape of cylinder. The left end of the main body 2 is closed by an end plate 2a, while the right end of the main body 2 is freely openable with a lid 2b which is opened for an inspection of the inside of the reaction cylinder 1 and an exchange of amplification agent 8 mentioned after.

The main body 2 has a plurality of electric heaters 3.3 . . . 3 on its outer surface. Each heater 3 is provided with a heating surface (inner surface) which is in close contact with wide area of the outer surface of the reaction cylinder 1 so as to heat effectively the main body 2 and a carbon cylinder 4 adhered to the inner surface of the main body 2. The left end of the carbon cylinder 4 is closed by an end plate 4a and its right end is openable with the lid 2b. The main body 2 and the carbon cylinder 4 are provided with both of an inflow pipe 5 for feeding gas to be treated on the left side thereof while a discharge pipe 6 on the right side thereof.

The both pipes 5 and 6 extend through thickness of both the main body 2 and the reaction cylinder 1 to open to the inside of the carbon cylinder 4. As gases to be treated in the carbon cylinder 4, for example, carbon dioxide (CO₂), steam (H₂O) and ammonia (NH₃) are selected (enumerated). A tray 7 made of stainless steel is detachably put on the bottom of the carbon cylinder 4 in order to accommodate amplification agent 8 therein which amplifies energy of the electromagnetic waves ejected from the inner surfaces of the main body 2 and the carbon cylinder 4.

In addition, instead of the bandlike electric heater 3, a cylindrical rod heater 40 may be disposed in the carbon cylinder 4 to heat efficiently the inner space of the carbon cylinder 4. The carbon cylinder 4 can eject ideal electromagnetic waves similar to black body ejection. However, as the main body 2 made of stainless steel can also eject ideal electromagnetic waves, only main body 2 can be used without the carbon cylinder 4. When the main body 2 and the carbon cylinder 4 are heated, the amplification agent 8 is partly vaporized to generate fine particles which float in an inner space of the carbon cylinder 4 to form a wave energy space W mentioned after in detail.

### 2) Structure of the Reactor Cylinder

It is important that the reactor cylinder 1 emits electromagnetic waves including standing waves. In FIG. 2, three standing waves S1, S2 and S3 are shown and both ends of each standing wave are fixed at the opposed inner surfaces of the carbon cylinder 4, respectively. In each electromagnetic wave, integer multiple n of ½ wavelength is equal to the diameter D of the carbon cylinder 4 and n=1 means that half of one wavelength is equal to the diameter D, and, accordingly, n=2 means that one wavelength is equal to the diameter D, and, further, n=3 means that one and half wavelength is equal to the diameter D. In each standing wave, a going wave overlaps on its returning wave with each other, so that the energy of the standing waves is in proportion to square of the number n. Accordingly, each physical energy (E, E₂ or E₃) becomes proportional to square of frequency (v) of each standing wave.

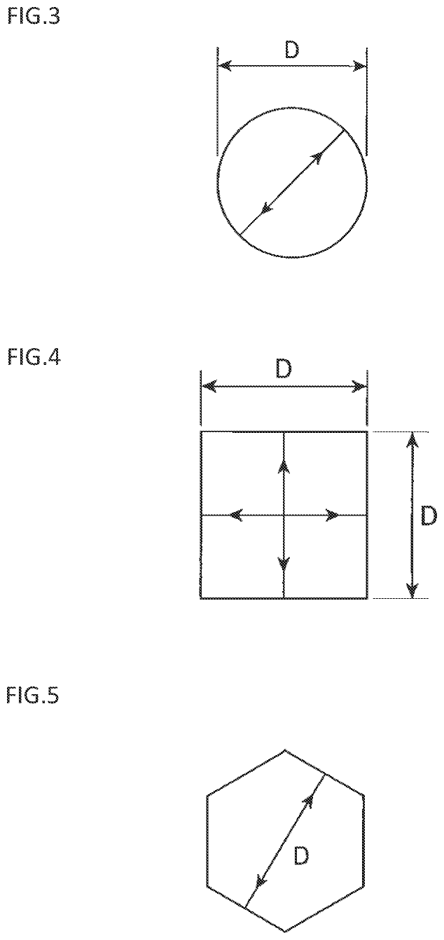

Thus, ejection of the standing waves can contribute to increase the physical energy in the wave energy space W. In order to emit standing waves, it is preferable that sectional shape of the carbon cylinder 4 is circle with a diameter D (in FIG. 3), square with a side D (in FIG. 4) or hexagonal with a distance D between opposed sides.

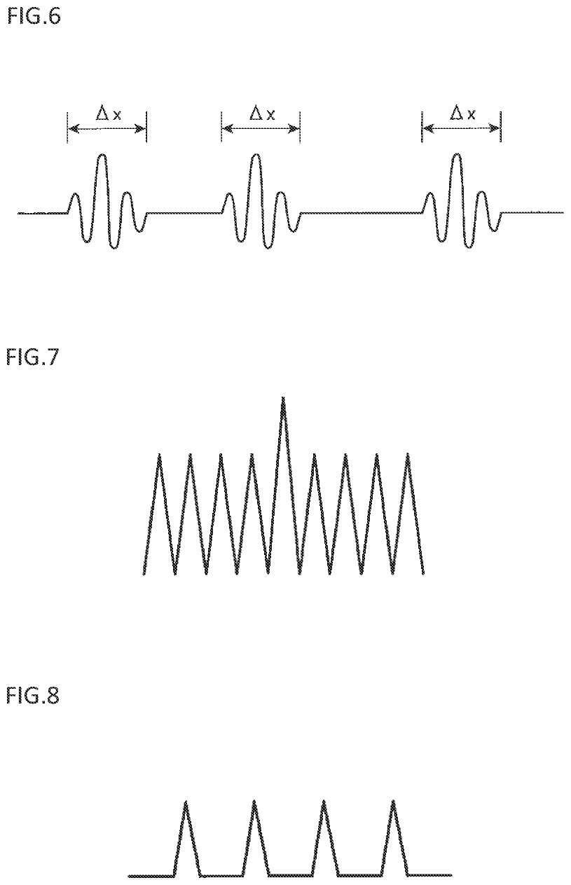

Next, the material of the main body 2 and the carbon cylinder 4 will now be explained. The main body 2 and the carbon cylinder 4 must eject electromagnetic waves including many and different amplitudes and frequencies so as to form wave packets as shown in FIG. 6. From this point of view, the main body 2 made from stainless steel and the carbon cylinder 4 made of carbon are almost ideal materials, respectively. In FIG. 1, the carbon cylinder 4 is in contact with the inner surface of the main body 2, and, however, it is not necessarily provided together with the main body 2. The carbon cylinder 4 can contribute in such a manner that, in the case of treatment of carbon dioxide (CO₂), oxygen atoms (O) in CO₂ oxidize the inner surface of the carbon cylinder 4 to produce only CO₂ (gas). Therefore, oxide film is not formed on the inner surface of the carbon cylinder 4.

In FIG. 6, in case that amplitude and frequency of the electromagnetic waves are continuously changed, wave packets having width of Δx are intermittently formed, and the following formula is established.

$$Δ x \cdot Δ p ≧ ℏ \qquad Δ p : momentum$$

That is, if the width Δx becomes small, uncertainty Δp of momentum becomes large, and there is a possibility that a large momentum is generated. That is, the stainless steel and the carbon can eject ideal electromagnetic waves to generate narrow wave packets, and, therefore, a high energy can be generated intermittently in the wave space W.

As mentioned above, in the wave energy space W, a high energy can be generated intermittently by the standing waves and wave packets, and the generation of the high energy was measured by a plasma measurement device. FIG. 7 shows the change of current value at that time. That is, the current value oscillates largely up and down, and this means that energy in the wave energy space W changes largely in an extremely short time.

As shown in the above, it can be speculative that a high energy is generated intermittently in shape of Fourier series as shown in FIG. 8.

The uncertainty principle is applied to the relationship between largeness of energy and its generation time in addition to the relationship between largeness p of momentum and width x of the wave packet as mentioned above. Namely, the relationship between uncertainty ΔE of the energy and uncertainty Δt of generation time is as follows.

$$Δ E \cdot Δ t ≧ ℏ$$

The formula means that an extremely large energy can be generated in an extremely short time without application of law of conservation of energy.

When a high energy is generated in shape of sharp pulses at a predetermined period, if it breaks symmetry in vacuum spaces of nucleuses of both fine particles of the amplification agent 8 and atoms of the treated gas, nuclear forces maintained in those vacuum spaces are cut off to separate nucleons (protons and neutrons) from each other. At this time, it is needless to say that electrons of each atom jump outward.

### 3) Amplification Agent

This amplification agent 8 functions to amplify energy of the electromagnetic waves. Generally, an atom, a nucleus 30 at the center of an atom, and one or more electrons rotate around the nucleus. Each material has different number in protons, neutrons or electrons. Therefore, almost any kind of material can be used as the amplification agent 8, and, however, alkaline metals (Na, K, Li, etc.) are most preferable because their ionization energy is relatively small. Further, alkaline earth metals (Ca, Mg, etc.) are effective, and, however, atoms such as Oxygen (O) and Chlorine (Cl) are not preferable because they are negative in electrical characteristics to absorb electrons.

In case that a metal sodium (Na) is used as an application agent, the action and function thereof will now be explained in detail.

In FIG. 1, when the bandlike electric heater 3 is operated at a temperature of 500 to 600° C., the main body 2, the carbon cylinder 4 and the tray 7 emit respectively electromagnetic waves with many and different amplitudes and frequencies, and, in FIG. 10, these electromagnetic waves r₁ and r₃ emitted from the main body 2 and the carbon cylinder 4 into Na atoms in the tray 7. If the wave n passes near an electron e₁⁻, the electron e₁⁻ ejects inductively another magnetic wave r₂ in parallel to the wave r₁ to increase number of waves. There are two types of means for amplification of the electromagnetic waves, and one type is to increase the number of waves as mentioned above. Another type is to increase the number of the frequency of the wave because of E=hv. In case that another wave r₃ collides with an electron e₂⁻ rotating around the nucleus 30, the electron e₂³¹ absorbs the energy of the wave r₃ to be jumped out of its orbit, and the electron e₂⁻ can move freely while it oscillates violently to emit electromagnetic waves r₄, r₄ . . . r₄ with a higher frequency than before. In addition, the wave r₄ of the free electron e₃⁻ enters other Na atoms to induce other waves or to eject waves with higher frequencies. In this manner, the metal Na is excited by the electromagnetic waves to become fine particles so as to float in the wave energy space W, while the fine particles are exposed to the electromagnetic waves.

### 4) Wave Energy Space

In a state wherein the fine particles move at a high speed in the wave energy space while being exposed to the electromagnetic waves, Na atoms of fine particles are ionized to become Na⁺ ion which is so formed that one electron is jumped out of each atom, Na²⁺ ion which is so formed that two electrons jump out of the Na atom . . . and Na^{x+} ion which is so formed that x electrons jump out of the Na atom, while these jumped electrons moves freely, and, at the same time, these Na ions are excited to increase those temperatures, so that a part of those ions is vaporized to fill the wave energy space with solid fine particles and vaporized Na ions. In this manner, ionized Na particles and free electrons coexist in the wave energy space, and this state may be called “plasma”. Energy of the plasma was measured by a plasma measurement device, and its result is shown in FIG. 7 as mentioned above in which current values oscillate violently up and down. The violent oscillation shows that energy of the wave energy space W goes up and down in an extremely short period of time. Accordingly, as a physical phenomenon, energy may be generated, in a state of pulses, intermittently as shown in FIG. 8.

A lot of verification tests showed generation of hydrogen and, it is judged that an energy larger than the nuclear force of Na nucleuses is generated, which now will be calculated in the following manner. One Na nucleon (nucleuses or one neutron) has approximately 8. 0 MeV per one nucleon, and, one Na atom has 22 nucleons (11 protons and 11 neutrons). Accordingly, nuclear force of one Na atom is as follows.

$$8. \times {10}^{6} ( MeV ) \times 22 {≐}_{.} 2.82 \times 1 {0}^{- 11} J$$

This value can be converted to frequency of electromagnetic wave. That is,

$$E = hv$$

$$v = \frac{h}{E} = \frac{6.63 \times 1 {0}^{- 34}}{2.82 \times 1 {0}^{- 11}} {≐}_{.} 4.2 \times 1 {0}^{22} ( Hz )$$

This frequency is in a range of γ ray. The wave energy space includes Na ions and electrons jumping out of the Na atom and electromagnetic waves including standing waves and wave packets. Na ions and electrons are particles, and, however, eject matter wave as Dr. de Broglie says. Therefore, the wave energy space has both wave nature and particle nature to generate two wave and particle types of energies.

### 5) Binding Energy

FIG. 11 shows binding energies with respect to mass numbers. At present, in a nuclear power plant, ²³⁵U is fissioned to obtain heat energy. For example, ²³⁵U is separated into barium (Ba) and krypton (Kr) at the time of fission, and the difference between the binding energy of barium and that of iron which has the largest binding energy among all elements corresponds to the largeness of heat energy, and, further, the difference between the binding energy of krypton (Kr) and that of iron corresponds to the largeness of heat energy.

On the contrary, in case that an atom e.g., sodium (Na) which has a mass number smaller than that of iron fissions to generate hydrogen H (proton), difference between the binding energy of Na and that of H (proton) corresponds to largeness of endothermic reaction in which mass of H slightly increases because heat from the endothermic reaction is transformed into a mass. The increased mass largeness is calculated in the following manner.

$$E = {mc}^{2} \qquad c : velocity of light$$

$$m = E / {c}^{2}$$

$$E = 8. MeV \times 1.6 \times 1 {0}^{- 19} {≐}_{.} 1.3 \times 1 {0}^{- 18} J$$

$$m = 1. 3 \times 1 {0}^{- 18} / {( 30 , 000 )}^{2} m = 1.4 \times 1 {0}^{- 9} kg = 1.4 \times 1 {0}^{- 6} g$$

That is, approximately 1.4×10⁻⁶ g is increased.

### 6) Balance Between Exothermic and Endothermic Reactions

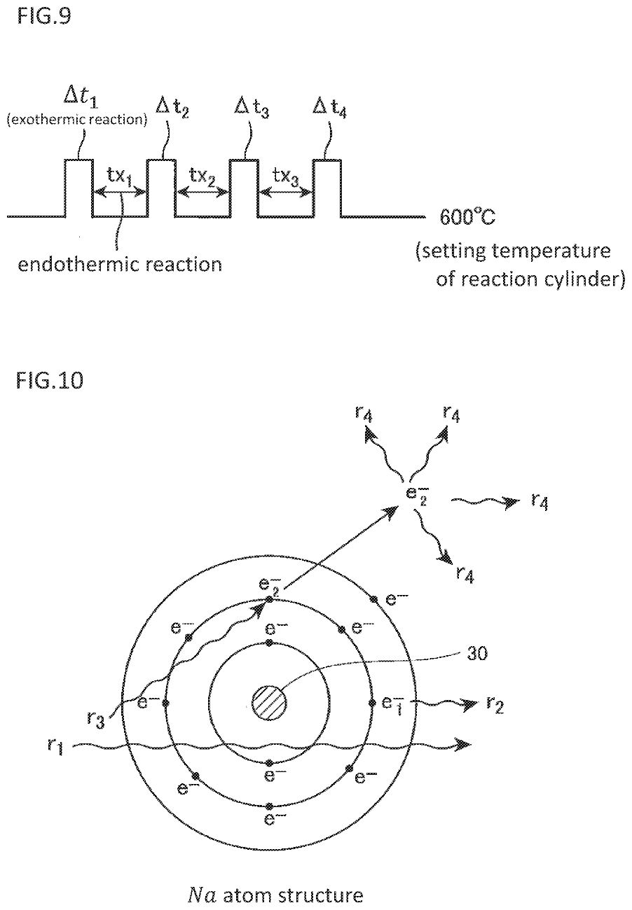

A high energy is generated in a predetermined period of time intermittently on the basis of uncertainty principle, in a shape of pulses in the wave energy space W to cause a nuclear fission. As shown in FIG. 9, when the high energy is generated, a gaseous Na ion moving at a high speed is exposed to the high energy in shape of waves and particles, so that the nucleus of the Na ion is collapsed into 11 protons and 11 neutrons to absorb the high energy. In other words, the number of collapses of Na atoms correspond to strength of the generated high energy to maintain temperature in the wave energy space W at e.g., 600° C. Therefore, the reaction cylinder 1 can be operated safely. In more detail, when an exothermic reaction occurs in an extremely short time Δt₁, nucleuses of Na atoms are collapsed instantly to cause endothermic reaction in a short time tx₁, and the second exothermic reaction is generated after a time tx₁ in a short time Δt₂. In this manner, the same operations are repeated, and times of third and fourth exothermic reactions are Δt₃ and Δt₄ respectively while times of second and third endothermic reactions are tx₂ and tx₃, respectively.

### 7) Supply of Gas to be Treated

If the amplification agent 8 is selected so that its mass is smaller than that of iron and the constituent atoms of the gas to be treated have masses each smaller than that of iron, cycle of exothermic and endothermic reactions is certainly repeated. For example, in case that carbon dioxide (CO₂) is fed into the reaction cylinder 1, at first, the carbon atom (C) and the oxygen atom (O) are separated from each other by the intermittent energy. At this time, the separated carbon atom is solid to be easily captured on the inner surface of the carbon cylinder 4, and the oxygen atom is mainly collapsed, so that some protons, neutrons and electrons are added to the wave energy space W. However, a part of the oxygen atoms is combined with Na ions to make some oxygen compounds such as NaO, NaOH and Na₂CO₃. To avoid these oxygen compounds, it is preferable that the reaction cylinder 1 is heated at a temperature above 1000° C. at which those oxygen compounds are vaporized to function as another amplification agent 8. As other gases to be treated, ammonia gas (NH₃) and steam (H₂O) are selected. In case of NH₃, it is treated to make it harmless, and, in case of H₂O, a lot of hydrogen can be obtained.

### 8) Artificial Symmetry Breaking in Vacuum Space

Dr. NAMBU is afraid of “spontaneous symmetry breaking” in vacuum universe. From the point of view, the inventor of this invention focuses on a vacuum space in a nucleus of an atom. The vacuum space has some protons and neutrons therein held by nuclear force. The vacuum space in universe is opposed to cosmic rays, strong electromagnetic waves, etc., to be going to break. Accordingly, it is imaginable that the vacuum space in a nucleus breaks by means of high energy. When the energy space W is artificially controlled, the fission and fusion can be controlled by an operator.

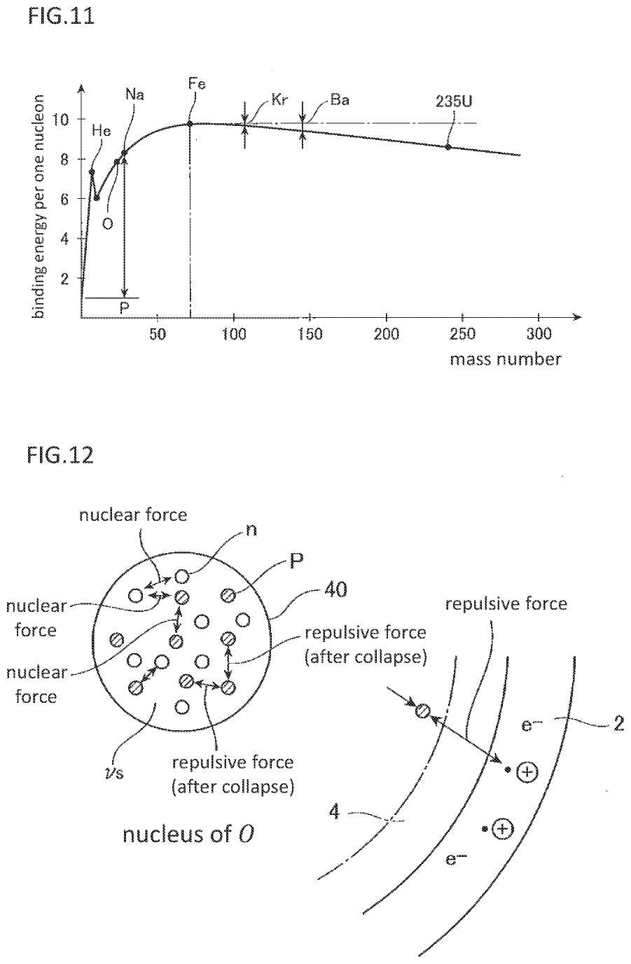

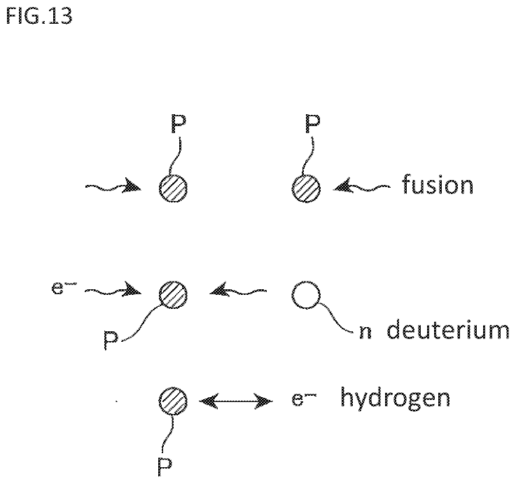

FIG. 12 shows a structure of a nucleus of an oxygen atom O in which 8 protons p and 8 neutrons n exist, and tensile forces work between a proton and a proton, a proton and a neutron and a neutron and a neutron regardless of charge to maintain the structure of the nucleus, firmly. The tensile forces are called nuclear force. Those protons p and neutrons n themselves vibrate to eject electromagnetic waves. In the vacuum space, almost part thereof is vacuum, and those protons p and neutrons n occupy only a small space. In the vacuum space, the nuclear force is normally maintained by quantum field formed under the influence of gluons in nucleons. However, when a high energy is generated in the wave energy space W, the vacuum state in the vacuum space vs is artificially broken to cut off the nuclear forces, so that the nucleus is collapsed.

### 9) Behavior of Proton, Neutron and Electrons After Collapse

When the nuclear force is cut off to collapse the nucleus, one proton p receives a repulsive force by another proton p, and both protons fly out in opposite directions with each other. Even if the protons could pass through the wall of the carbon cylinder 4, it could not pass through the main body 2 made of stainless steel which has many plus charge of free electrons to refuse the proton p by its repulsive force. Concerning the neutrons n at that time, they float in the wave energy space W because of no repulsive force. Up until now, the inventor never detected the neutrons n around the reaction cylinder 1 with a neutron detection device.

### 10) Reunion

In case that a nucleus is collapsed, protons p, neutrons n and electrons move freely in all directions at high different speeds. For example, when two protons p and p come close to each other, and, at that time, a high energy is generated to give the high energy to both protons p and p, one proton p is reunited with another proton p to obtain heat by that phenomenon which is called nuclear fusion. In a certain verification test, the temperature of the reaction cylinder 1 was increased suddenly at a temperature above 200° C. However, at the time of next generation of a high energy, the reunited pair is separated to lower the temperature of the reaction cylinder 1 to return to a normal state. Further, when one proton is reunited with one neutron to form a nucleus including one proton and one neutron. If one electron is reunited with the nucleus, deuterium is formed. A proton p is easily reunited with an electron e⁻ to form hydrogen.

### UTILIZATION POSSIBILITY IN THE FIELD OF INDUSTRY

This invention can be used in the field of transaction of harmful materials such as carbon dioxide (CO₂), ammonia (NH₃), etc., and also in the field of hydrogen related business.

### EXPLANATION OF NUMERALS

1 . . . reaction cylinder
2 . . . main body
3 . . . bandlike electric heater
4 . . . carbon cylinder
7 . . . tray
8 . . . amplification agent
30 . . . nucleus of O

1. A method of wave energy space reaction, wherein:
an amplification agent is accommodated in a reaction cylinder ejecting electromagnetic waves by being heated to amplify energy of the electromagnetic waves so as to form a wave energy space therein including ionized fine particles of the amplification agent and electrons;
a high energy is generated intermittently in accordance with uncertainty principle;
both atoms of the amplification agent and gas to be treated comprise masses smaller than iron, and each atom has a nucleus with a vacuum space in which some protons and neutrons oscillates;
when the vacuum space is exposed to the high energy, it is collapsed to cut off nuclear force held in the vacuum space so as to separate protons and neutrons with each other; and
the high energy generated in the wave energy space is absorbed by collapse of the vacuum space.

2. A wave reaction method according to claim 1, wherein the reaction cylinder ejects electromagnetic waves including many and different amplitudes and frequencies.

3. A wave reaction method according to claim 1, wherein the reaction cylinder is in the shape of circle, rectangular or hexagon, in cross section and ejects standing waves by its heating.

4. A wave reaction method according to claim 1, wherein the amplification agent comprises at least one atom of alkaline metals (Na, K, Li, etc.), alkaline earth metals (Mg, Ca, etc.) and active metals (Zn, Al, etc.) or at least one compound including the one atom in those metals, and the gas to be treated in the reaction cylinder is carbon dioxide (CO₂), steam (H₂O) and ammonia (NH₃).

5. A wave reaction apparatus, comprising:
a reaction cylinder which is made of material for ejecting electromagnetic waves by its heating;
an amplification agent which is accommodated in the reaction cylinder in order to amplify energy of the electromagnetic waves and which has a smaller mass than iron;
a heating equipment for heating the reaction cylinder and the amplification agent;
a wave energy space, formed in the reaction cylinder, which includes therein a first mixture of ionized fine particles as the amplification agent and electrons jumping out of the fine particles or a second mixture of the first mixture and constituent atoms, in gas to be treated, each having a smaller mass than iron and which has wave nature and particle nature at the same time; and
a vacuum space which is formed in each of nuclei of atoms in the amplification agent and the gas to be treated.

6. A wave reaction apparatus according to claim 5, wherein the reaction cylinder is made of stainless steel or iron.

7. A wave reaction apparatus according to claim 5, wherein the heating device comprises a bandlike electric heater wound on the outer circumferential surface of the reaction cylinder.
